(19) United States
(12) Patent Application Publication
(10) Pub. No.: US 2024/0116064 A1
(43) Pub. Date: Apr. 11, 2024

(54) WATER OUTLET DEVICE AND INTELLIGENT CLOSESTOOL

(71) Applicant: XIAMEN SOLEX HIGH-TECH INDUSTRIES CO., LTD., Fujian (CN)

(72) Inventors: Shilong WU, Fujian (CN); Junxiao LV, Fujian (CN); Qinghua ZHAN, Fujian (CN); Donghai CHEN, Fujian (CN)

(21) Appl. No.: 18/562,116

(22) PCT Filed: May 6, 2022
(86) PCT No.: PCT/CN2022/091235

§ 371 Date: Nov. 17, 2023

(30) Foreign Application Priority Data
May 20, 2021 (CN) 202110551942.9

(51) Int. Cl. B05B 7/04; B05B 7/12

(52) U.S. Cl. CPC B05B 7/0408; B05B 7/12

(57) ABSTRACT

Provided are a water outlet device (1) and an intelligent closestool. The water outlet device (1) includes a core (100). The core (100) includes a mixing chamber (110), one or more first water inlets (120), one or more second water inlets (130), and a water outlet (140). The water outlet (140) connects with the mixing chamber (110). A tangential direction, a radial direction, and an axial direction of the mixing chamber (110) are defined. The one or more first water inlets (120) are disposed in the mixing chamber (110) along the tangential direction so that a water flow entering the mixing chamber (110) from the one or more first water inlets (120) is capable of forming a vortex. The one or more second water inlets (130) are disposed in the mixing chamber (110) along the axial direction or the radial direction so that a water flow entering the mixing chamber (110) from the one or more second water inlets (130) is capable of forming a stable water flow. The water outlet is capable of spraying water flows in different states by adjusting the water intake ratio of the one or more first water inlets (120) and the one or more second water inlets (130).

### CROSS-REFERENCE TO RELATED APPLICATIONS

This is a national stage application filed under 37 U.S.C. 371 based on International Patent Application No. PCT/CN2022/091235, filed May 6, 2022, which claims priority to a Chinese patent application No. 202110551942.9 filed on May 20, 2021, the disclosures of which are incorporated herein by reference in their entireties.

### TECHNICAL FIELD

The present disclosure relates to the technical field of water outlet devices and, in particular, to a water outlet device capable of achieving different water in the same hole and an intelligent closestool.

### BACKGROUND

Currently, users have more and more diverse requirements for the water output state of a water outlet device. To satisfy the different requirements of the users, the water outlet device needs to be designed to be capable of spraying water flows in different states. For example, a spray rod of an intelligent closestool needs to switch between functions such as buttock washing and feminine washing.

However, in the related art, different water outlet pipes connect with different water outlet nozzles so that the water flows in different states are sprayed. Therefore, the structure of the spray rod is relatively complicated, and the number of the states of the water flows sprayed from the spray rod is determined by the number of the provided water outlet nozzles, which cannot satisfy the abundant water flow states, resulting in relatively poor user experience.

### SUMMARY

Embodiments of the present disclosure provide a water outlet device with a simple structure and capable of spraying water flows in different states from the same water outlet.

An embodiment of the present disclosure further provides an intelligent closestool including the preceding water outlet device.

A water outlet device in an embodiment of the present disclosure includes a core, where the core includes a mixing chamber, one or more first water inlets, one or more second water inlets, and a water outlet, where the water outlet connects with the mixing chamber.

A tangential direction of the mixing chamber, a radial direction of the mixing chamber, and an axial direction of the mixing chamber are defined; the one or more first water inlets are disposed in the mixing chamber along the tangential direction so that a water flow entering the mixing chamber from the one or more first water inlets is capable of forming a vortex; and the one or more second water inlets are disposed in the mixing chamber along the axial direction or the radial direction so that a water flow entering the mixing chamber from the one or more second water inlets is capable of forming a stable water flow.

The water outlet is capable of spraying water flows in different states by adjusting the water intake ratio of the one or more first water inlets and the one or more second water inlets.

According to some embodiments of the present disclosure, the centerline of the water outlet coincides with the axis of the mixing chamber.

According to some embodiments of the present disclosure, the cross-sectional area of the mixing chamber closer to the water outlet gradually decreases.

According to some embodiments of the present disclosure, the aperture of the water outlet is between 1 mm and 2 mm.

Alternatively, the flow area of the water outlet is between 0.8 mm² and 3 mm².

According to some embodiments of the present disclosure, the one or more second water inlets are disposed in the mixing chamber along the radial direction.

The centerline of one of the one or more first water inlets is basically perpendicular to the centerline of one of the one or more second water inlets.

According to some embodiments of the present disclosure, the inner wall surface of the mixing chamber is an arc-shaped curved surface, and the shape of the arc-shaped curved surface is a truncated cone, a cone, an ellipsoid, or a cylinder.

According to some embodiments of the present disclosure, the water outlet device further includes a water diversion valve, where the water diversion valve is configured to enable the water flow to selectively enter the one or more first water inlets and/or the one or more second water inlets.

According to some embodiments of the present disclosure, the water diversion valve includes a valve seat and a moving member.

The valve seat includes a first water diversion hole and a second water diversion hole, where the first water diversion hole connects with the one or more first water inlets, and the second water diversion hole connects with the one or more second water inlets.

The moving member is movably connected to the valve seat and includes a third water diversion hole, where the third water diversion hole is capable of connecting with a water supply pipe.

When the moving member moves relative to the valve seat, the third water diversion hole selectively corresponds to the first water diversion hole and/or the second water diversion hole.

According to some embodiments of the present disclosure, the valve seat and the moving member are both disc-shaped and rotatably stacked on each other.

The first water diversion hole, the second water diversion hole, and the third water diversion hole are all waist-shaped holes, and the first water diversion hole and the second water diversion hole extend along the circumferential direction of the valve seat and are arranged at intervals.

The third water diversion hole extends along the circumferential direction of the moving member.

An intelligent closestool in an embodiment of the present disclosure includes the water outlet device described in any one of the above.

An embodiment of the preceding disclosure has the advantages or beneficial effects described below.

Compared with the method in which different water outlet pipes connect with different water outlet nozzles in the related art, the water outlet device in the embodiment of the present disclosure adopts the technical method in which the first water inlets are disposed in the mixing chamber along the tangential direction and the second water inlets are disposed in the mixing chamber along the radial direction so that the states of the water flows sprayed from the water outlet can be adjusted according to the water intake ratio of the first water inlets and the second water inlets, the effect of different water in the same hole is achieved, the advantages of a simple structure and more abundant water flow states are ensured, and the requirements of different users for different water flow states can be satisfied.

In addition, when switching between different water flow states, the water outlet device in the embodiment of the present disclosure can continuously spray warm water without waiting, significantly improving user experience.

### BRIEF DESCRIPTION OF DRAWINGS

The above and other features and advantages of the present disclosure become more apparent by describing the example embodiments thereof in detail with reference to the drawings.

FIG. 1 is a perspective view of a spray rod according to an embodiment of the present disclosure.

FIG. 2 is an exploded view of a spray rod according to an embodiment of the present disclosure.

FIG. 3 is a perspective view of a water outlet device according to an embodiment of the present disclosure.

FIG. 4 is a sectional view taken along A-A in FIG. 3.

FIG. 5 is a structural view of a core from a perspective according to an embodiment of the present disclosure.

FIG. 6 is a structural view of a core from another perspective according to an embodiment of the present disclosure.

FIG. 7 is a sectional view of a core according to an embodiment of the present disclosure.

FIG. 8 is a structural view of a core according to another embodiment of the present disclosure.

FIG. 9 is a sectional view taken along the centerline of a second water inlet of a core according to another embodiment of the present disclosure.

FIG. 10 is a sectional view taken along the axis of a mixing chamber of a core according to another embodiment of the present disclosure.

FIG. 11 is a structural view of a valve seat according to an embodiment of the present disclosure.

FIG. 12 is a structural view of a moving member according to an embodiment of the present disclosure.

FIG. 13 is a schematic view illustrating that water comes out from only a first water diversion hole in a water diversion valve according to an embodiment of the present disclosure.

FIG. 14 is a schematic view illustrating that water comes out from both a first water diversion hole and a second water diversion hole in a water diversion valve according to an embodiment of the present disclosure.

FIG. 15 is a schematic view illustrating that water comes out from only a second water diversion hole in a water diversion valve according to an embodiment of the present disclosure.

FIG. 16 is a schematic view illustrating that a water flow in a first state flows out from a water outlet device according to an embodiment of the present disclosure.

FIG. 17 is a schematic view illustrating that a water flow in a second state flows out from a water outlet device according to an embodiment of the present disclosure.

FIG. 18 is a schematic view illustrating that a water flow in a third state flows out from a water outlet device according to an embodiment of the present disclosure.

### REFERENCE LIST

1 water outlet device
2 spray rod body
100 core
110 mixing chamber
120 first water inlet
130 second water inlet
140 water outlet
150 first flow channel
160 second flow channel
200 water diversion valve
210 valve seat
211 first water diversion hole
212 second water diversion hole
220 moving member
221 third water diversion hole
300 upper cover
400 lower cover

### DETAILED DESCRIPTION

Example embodiments are described more fully with reference to the drawings. However, example embodiments may be implemented in many different forms and are not to be construed as limited to the embodiments set forth herein; rather, these embodiments are provided so that the present disclosure is thorough and complete and the concept of the example embodiments is fully conveyed to those skilled in the art. The same reference numerals in the drawings denote the same or similar structures, and thus a detailed description of the same reference numerals is not repeated.

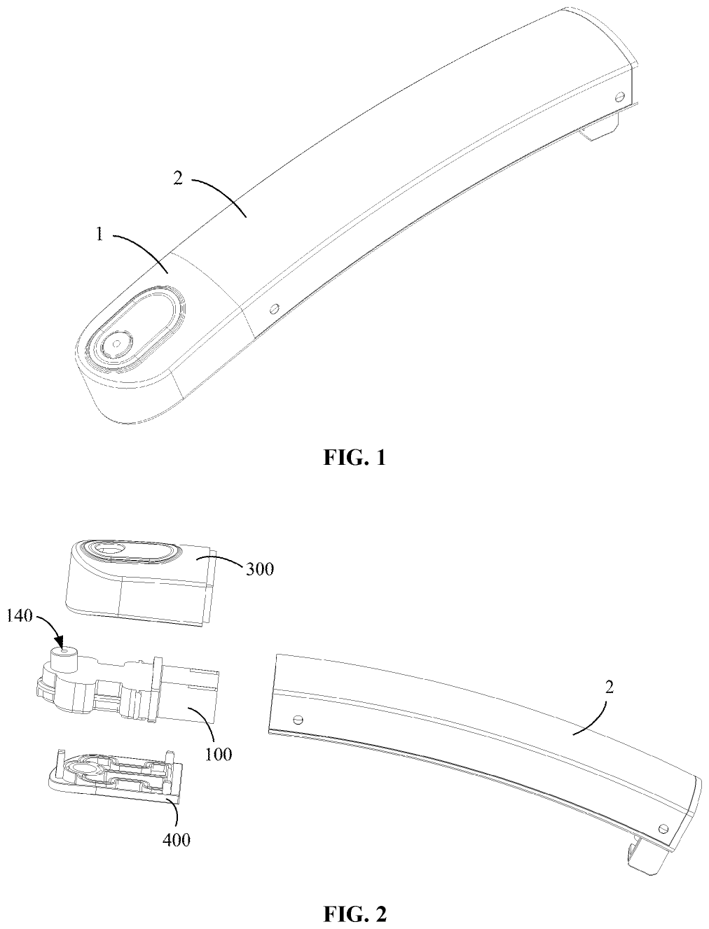

As shown in FIGS. 1 and 2, FIG. 1 is a perspective view of a spray rod according to an embodiment of the present disclosure, and FIG. 2 is an exploded view of a spray rod according to an embodiment of the present disclosure. A water outlet device in the embodiment of the present disclosure is applied to an intelligent closestool. A water outlet device 1 is connected to a spray rod body 2 and used for implementing functions such as buttock washing and feminine washing. It is to be noted that the water outlet device 1 in the embodiment of the present disclosure is not limited to being applied to the intelligent closestool. For example, the water outlet device 1 may also be applied to a bathroom shower, a car wash spray gun, a kitchen faucet, or another suitable usage scenario, which is not specifically limited in the embodiment of the present disclosure.

The water outlet device 1 in the embodiment of the present disclosure includes a core 100, an upper cover 300, and a lower cover 400. The upper cover 300 may be configured to be a cover. The core 100 is accommodated in the upper cover 300. The lower cover 400 is fastened on the bottom of the upper cover 300 so that part of the core 100 is enclosed in a cavity formed by the upper cover 300 and the lower cover 400. The other part of the core 100 is exposed out of the cavity formed by the upper cover 300 and the lower cover 400 and connects with a flow channel of the spray rod body 2.

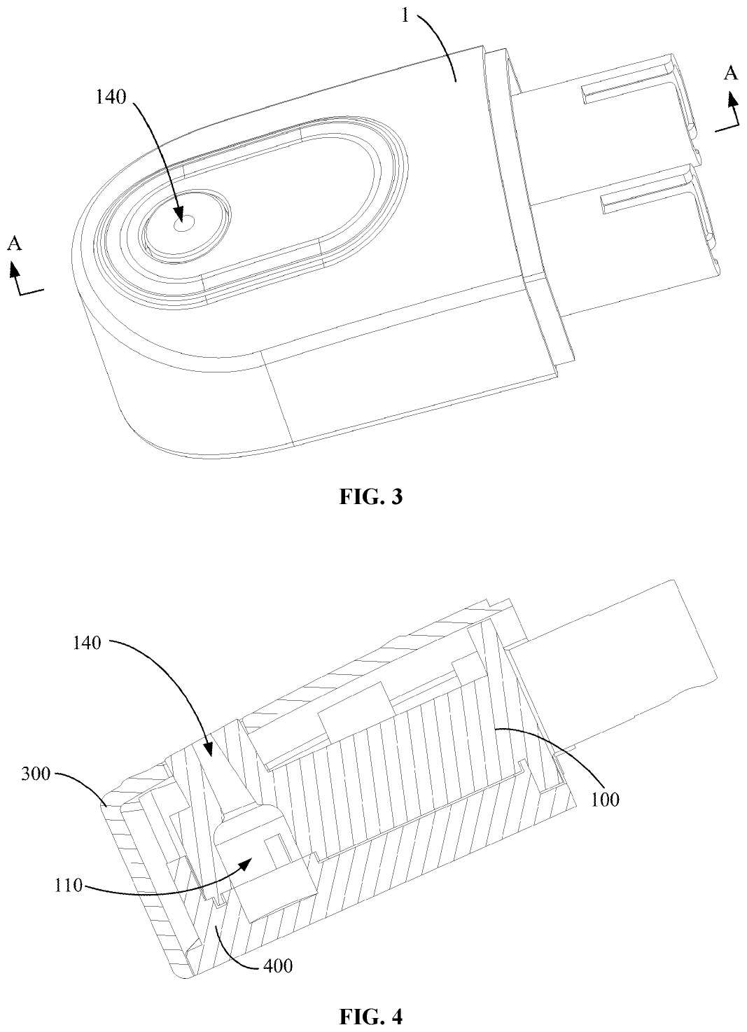

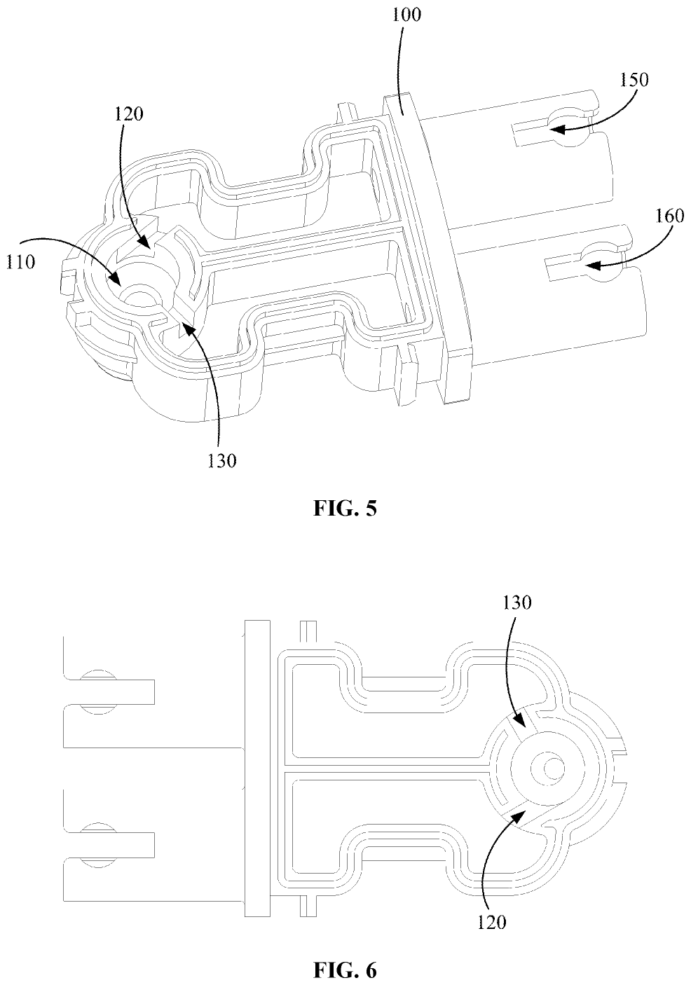

As shown in FIGS. 3 to 5, FIG. 3 is a perspective view of a water outlet device according to an embodiment of the present disclosure, FIG. 4 is a sectional view taken along A-A in FIG. 3, and FIG. 5 is a structural view of a core from a perspective according to an embodiment of the present disclosure. The core 100 in the embodiment of the present disclosure includes a mixing chamber 110, one or more first water inlets 120, one or more second water inlets 130, and a water outlet 140. The water outlet 140 connects with the mixing chamber 110.

The core 100 further includes a first flow channel 150 and a second flow channel 160. The first flow channel 150 connects with the first water inlet 120, and the second flow channel 160 connects with the second water inlet 130. The first flow channel 150 and the second flow channel 160 are independent of each other before being connected to the mixing chamber 110. The water flow may enter the mixing chamber 110 through the first flow channel 150 and the first water inlet 120 in sequence. The water flow may also enter the mixing chamber 110 through the second flow channel 160 and the second water inlet 130 in sequence. The water entering the mixing chamber 110 may finally be sprayed from the water outlet 140.

As shown in FIGS. 5 and 6, FIG. 6 is a structural view of a core from another perspective according to an embodiment of the present disclosure. A tangential direction of the mixing chamber, a radial direction of the mixing chamber, and an axial direction of the mixing chamber 110 in the embodiment of the present disclosure are defined. It is to be explained and noted that the tangential direction refers to a direction of a tangent line to an arc-shaped surface and is perpendicular to the normal direction; the radial direction refers to a direction along the diameter or radius of the arc-shaped surface; and the axial direction refers to a direction along the axis of the arc-shaped surface.

With continued reference to FIGS. 5 and 6, the first water inlet 120 is disposed in the mixing chamber 110 along the tangential direction. Since the flow direction of the first water inlet 120 is along the tangential direction of the mixing chamber 110, the water flow entering the mixing chamber 110 from the first water inlet 120 is in a stable vortex state. Due to the effect of a centrifugal force, the water flow is sprayed from the water outlet 140 in the form of a divergent granular water flow, that is, the water flow in a first state.

It is to be noted that the position of the first water inlet 120 should be understood as substantially along the tangential direction of the mixing chamber 110, rather than absolutely, as long as the water flow entering the mixing chamber 110 from the first water inlet 120 is able to generate a vortex.

The second water inlet 130 is disposed in the mixing chamber 110 along the radial direction. Since the flow direction of the second water inlet 130 is along the radial direction, the water flow entering the mixing chamber 110 from the second water inlet 130 does not generate a vortex, but is in a normal stable state. The water flow in the normal stable state is sprayed from the water outlet 140 in the form of a columnar water flow, that is, the water flow in a second state.

It is to be noted that the position of the second water inlet 130 should be understood as substantially along the radial direction of the mixing chamber 110, rather than absolutely. For example, the flow direction of the second water inlet 130 does not directly face the axis of the mixing chamber 110, but slightly deviates from the axis of the mixing chamber 110, so as to generate the water flow in a stable state, which should be within the scope of the present disclosure.

When the water flows enter the mixing chamber 110 from the first water inlet 120 and the second water inlet 130 at the same time, the water flow entering from the first water inlet 120 forms a vortex in the mixing chamber 110, and the water flow entering from the second water inlet 130 is in the normal stable state in the mixing chamber 110. The vortex is disturbed by the water flow in the normal stable state so that a fast and stable vortex cannot be formed, and finally, a divergent water flow, that is, the water flow in a third state, is sprayed from the water outlet 140. It is to be understood that the water flow in the third state is the water flow in an intermediate state between the water flow in the first state and the water flow in the second state.

It is worth mentioning that in the case where the ratio of the water flow entering from the first water inlet 120 to the water flow entering from the second water inlet 130 is larger, the vortex effect in the mixing chamber 110 is better, and the water flow sprayed from the water outlet 140 has a more obvious divergence effect. If the ratio is smaller, the divergence effect is less obvious.

It can be seen from this that, compared to the influence of the dimension of the spray rod in the related art and compared to the related art in which the water splash state is limited by the number of water outlet nozzles, in the water outlet device in the embodiment of the present disclosure, the water intake ratio of the first water inlet 120 and the second water inlet 130 is adjusted so that the water output form can be adjusted steplessly, a variety of water splash shapes can be formed, the water splash forms of the water output are more abundant, and the requirements of different users for different water flow states are satisfied.

It is to be understood that the inner wall surface of the mixing chamber 110 may be an arc-shaped curved surface, such as a truncated cone, a cone, or a cylinder. Of course, the inner wall surface of the mixing chamber 110 may also be in the shape of an ellipsoid. It is to be noted that the shapes of the inner wall surface of the mixing chamber 110 listed above are only for illustration and should not be construed as limiting the shape of the inner wall surface of the mixing chamber 110. Any shape of the inner wall surface that is able to enable the water flow entering the mixing chamber 110 from the first water inlet 120 to form a vortex in the mixing chamber 110 should be within the scope of the present disclosure.

In an embodiment, the centerline of the water outlet 140 coincides with the axis of the mixing chamber 110, which is not limited thereto.

As shown in FIG. 6, one first water inlet 120 and one second water inlet 130 may be provided, which is not limited thereto. For example, two or three first water inlets 120 may be provided, and two or three second water inlets 130 may be provided.

With continued reference to FIG. 6, the centerline of the first water inlet 120 is basically perpendicular to the centerline of the second water inlet 130, which is not limited thereto.

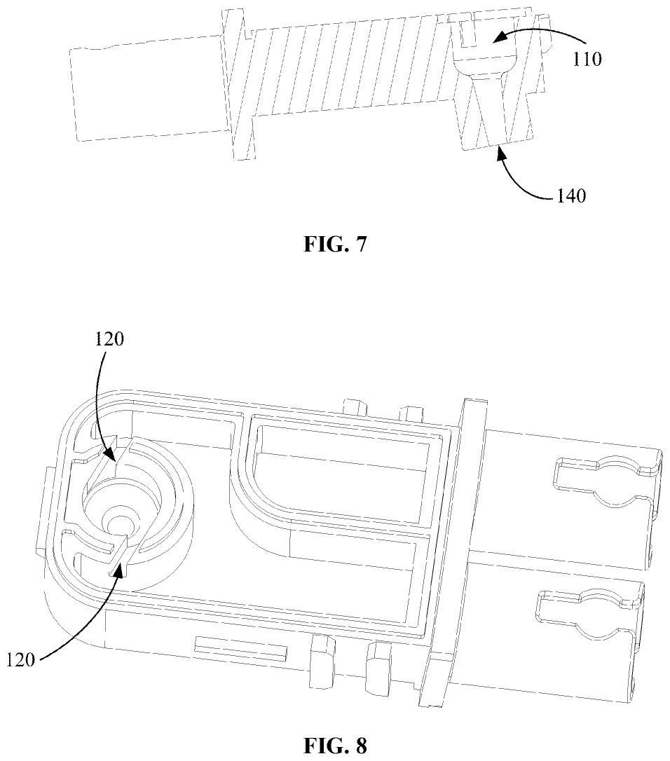

As shown in FIG. 7, FIG. 7 is a sectional view of a core according to an embodiment of the present disclosure. The aperture of the water outlet 140 is between 1 mm to 2 mm; or the flow area of the water outlet 140 is between 0.8 mm² to 3 mm². Within such a range of values, not only can the water output strength of the water splash be ensured, but also the water output flow can be controlled between 0.5 L/min and 1.5 L/min so that the water outlet device in the embodiment of the present disclosure can supply enough hot water even in cold weather.

In addition, the minimum aperture of the water outlet 140 is limited to 1 mm so that the scale is not easy to generate at the water outlet 140 after a long time of use and the water outlet 140 is more durable.

With continued reference to FIG. 7, the cross-sectional area of the mixing chamber 110 closer to the water outlet 140 gradually decreases, thereby forming a substantially beer-bottle shape or a cone shape. Such design can enable the water flow in the mixing chamber 110 to be sprayed from the water outlet 140 more easily.

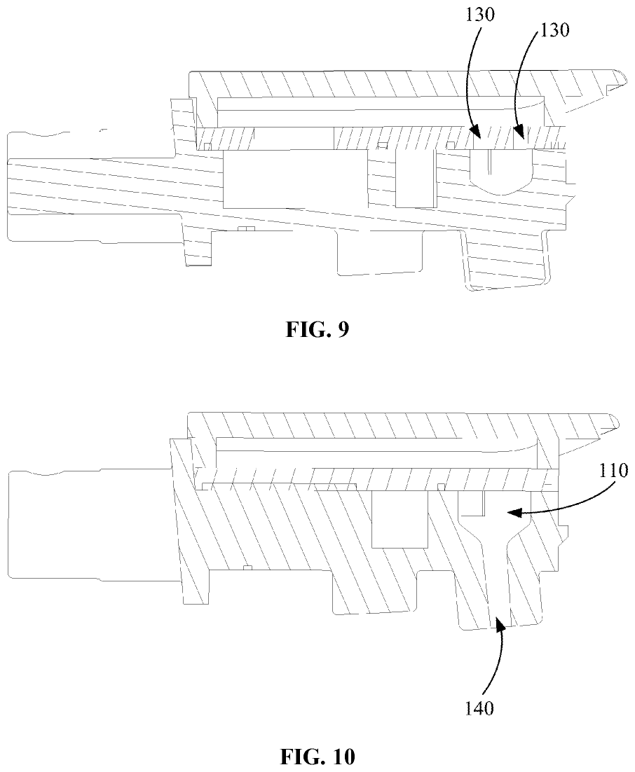

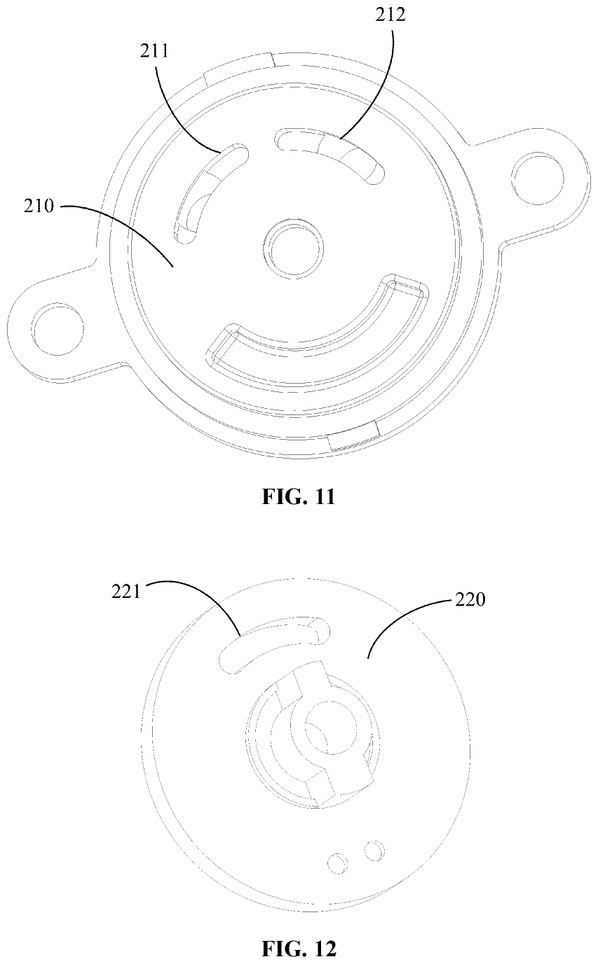

As shown in FIGS. 8 to 10, FIG. 8 is a structural view of a core according to another embodiment of the present disclosure, FIG. 9 is a sectional view taken along the centerline of a second water inlet of a core according to another embodiment of the present disclosure, and FIG. 10 is a sectional view taken along the axis of a mixing chamber of a core according to another embodiment of the present disclosure. The difference between the core 100 in this embodiment and the core 100 in the preceding embodiment is that the first water inlets 120 of the core 100 in this embodiment are disposed in the mixing chamber 110 along the tangential direction and the second water inlets 130 are disposed in the mixing chamber 110 along the axial direction. The centerlines of the second water inlets 130 may be staggered from the centerline of the water outlet 140.

Since the second water inlets 130 are disposed in the mixing chamber 110 along the axial direction, the water output strength of the water flow in the second state (the columnar water flow) is further ensured.

With continued reference to FIGS. 8 to 10, two first water inlets 120 may be provided, and the centerlines of the two first water inlets 120 are parallel to each other. The advantage of such design is that the effect of generating a vortex can be better.

Multiple second water inlets 130 may be provided. For example, two, three, or four second water inlets 130 may be provided.

In this embodiment, the cross-sectional area of the mixing chamber 110 closer to the water outlet 140 is also designed to gradually decrease, thereby forming a substantially beer-bottle shape or a cone shape. Such design can enable the water flow in the mixing chamber 110 to be sprayed from the water outlet 140 more easily.

As shown in FIGS. 11 and 12, FIG. 11 is a structural view of a valve seat according to an embodiment of the present disclosure, and FIG. 12 is a structural view of a moving member according to an embodiment of the present disclosure. The water outlet device in the embodiment of the present disclosure further includes a water diversion valve 200 configured to enable the water flow to selectively enter the first water inlet 120 and/or the second water inlet 130.

In an exemplary embodiment, a water supply pipe connects with the water diversion valve 200; after the water diversion valve 200 divides the water, the water flow supplied by the water supply pipe may selectively enter the first water inlet 120 and/or the second water inlet 130; and then the water flow in the first state, the water flow in the second state, or the water flow in the third state flows out from the water outlet 140.

In the intelligent closestool in the related art, since the water flow sprayed by the spray rod is sprayed on the buttocks of the human body, to avoid cold water from irritating the user and bringing a bad experience, the current spray rod sprays warm water. For the spray rod in the related art, the method in which different water outlet pipes connect with different water outlet nozzles is adopted so that the spray rod may switch between functions such as buttock washing and feminine washing. When one water outlet pipe and the water outlet nozzle connect with water, the other water outlet pipe and the other water outlet nozzle are not in use, causing the inside water flow to have gradually decreasing temperature and eventually become cold water. When the user switches from one water flow state to another water flow state, the cold water remaining in the unused water channel needs to be drained before the warm water can flow normally. During this process, the user needs to wait for a period of time, and the experience is relatively poor.

In the water outlet device of the embodiment of the present disclosure, the water diversion device 200 is provided so that the warm water can continuously flow through both the water channel of the first water inlet 120 and the water channel of the second water inlet 130. When the water flow state needs to be switched, the user does not need to wait, improving user experience. In an exemplary embodiment, the water flow in the water supply pipe connecting with the water diversion valve 200 may be heated in advance. During the water diversion process of the water diversion valve 200, whether the water flow in the first state, the water flow in the second state, or the water flow in the third state is sprayed out, the water flows in the flow channels in the water outlet device are both supplied by the same water supply pipe and are both the warm water.

With continued reference to FIGS. 11 and 12, the water diversion valve 200 in the embodiment of the present disclosure includes a valve seat 210 and a moving member 220, the valve seat 210 includes a first water diversion hole 211 and a second water diversion hole 212, the first water diversion hole 211 connects with the first water inlet 120, and the second water diversion hole 212 connects with the second water inlet 130. The moving member 220 is movably connected to the valve seat 210 and includes a third water diversion hole 221, where the third water diversion hole 221 is capable of connecting with a water supply pipe.

When the moving member 220 moves relative to the valve seat 210, the third water diversion hole 221 selectively corresponds to the first water diversion hole 211 and/or the second water diversion hole 212.

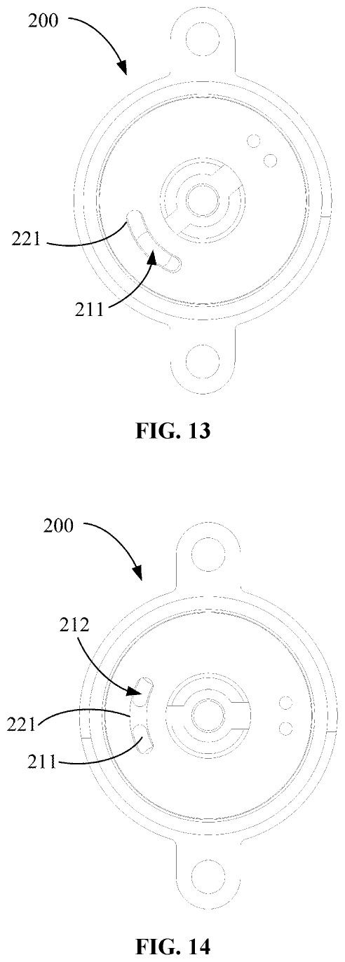

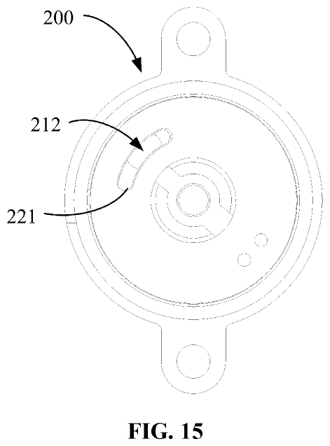

In an exemplary embodiment, as shown in FIGS. 13 to 15, FIG. 13 is a schematic view illustrating that water comes out from only a first water diversion hole in a water diversion valve according to an embodiment of the present disclosure, FIG. 14 is a schematic view illustrating that water comes out from both a first water diversion hole and a second water diversion hole in a water diversion valve according to an embodiment of the present disclosure, and FIG. 15 is a schematic view illustrating that water comes out from only a second water diversion hole in a water diversion valve according to an embodiment of the present disclosure.

As shown in FIG. 13, when the moving member 220 moves to a first position range relative to the valve seat 210, the third water diversion hole 221 corresponds to only the first water diversion hole 211, and the second water diversion hole 212 is blocked by the moving member 220. The water flow may pass through the third water diversion hole 221 and the first water diversion hole 211 and flow into the first water inlet 120, and finally, the water flow in the first state is sprayed out.

As shown in FIG. 14, when the moving member 220 moves to a second position range relative to the valve seat 210, the first water diversion hole 211 and the second water diversion hole 212 both correspond to the third water diversion hole 221 so that the water flow may separately pass through the first water diversion hole 211 and the second water diversion hole 212 from the third water diversion hole 221 and separately flow into the first water inlet 120 and the second water inlet 130, and finally, the water flow in the third state is sprayed out.

As shown in FIG. 15, when the moving member 220 moves to a third position range relative to the valve seat 210, the third water diversion hole 221 corresponds to only the second water diversion hole 212, and the first water diversion hole 211 is blocked by the moving member 220. The water flow may pass through the third water diversion hole 221 and the second water diversion hole 212 and flow into the second water inlet 130, and finally, the water flow in the second state is sprayed out.

It is to be understood that the correspondence between the two water diversion holes may be that the two water diversion holes are completely aligned, and at this time, the passing water flow has the maximum flow rate. Alternatively, the correspondence between the two water diversion holes may be that the two water diversion holes are partially aligned, and at this time, the flow rate of the passing water flow decreases.

With continued reference to FIGS. 11 and 12, the valve seat 210 and the moving member 220 are both disc-shaped and rotatably stacked on each other. The first water diversion hole 211, the second water diversion hole 212, and the third water diversion hole 221 are all waist-shaped holes, and the first water diversion hole 211 and the second water diversion hole 212 extend along the circumferential direction of the valve seat 210 and are arranged at intervals. The third water diversion hole 221 extends along the circumferential direction of the moving member 220.

In this example, the first water diversion hole 211, the second water diversion hole 212, and the third water diversion hole 221 are all waist-shaped holes, the first water diversion hole 211 and the second water diversion hole 212 extend along the circumferential direction of the valve seat 210, and the third water diversion hole 221 extends along the circumferential direction of the moving member 220. Therefore, when the moving member 220 rotates relative to the valve seat 210, the flow rates of the water flows passing through the first water diversion hole 211 and the second water diversion hole 212 can change slowly and evenly so that the outputted water flow can change steplessly, slowly, and evenly, and the water flow states are more abundant.

Of course, it is to be understood that the moving member 220 may move back and forth in a straight line relative to the valve seat 210; or the waist-shaped holes are changed into multiple small holes with different apertures, and the flow rate is adjusted by rotating the moving member 220, so as to achieve the water diversion effect; or the magnitudes of the openings of two valves are controlled, so as to control the water input flows of two channels and achieve the water diversion effect. In an exemplary embodiment, the opening areas of the valves may be separately controlled by two electric motors, so as to control the flow ratio and achieve the accurate control of the water flows of the two channels.

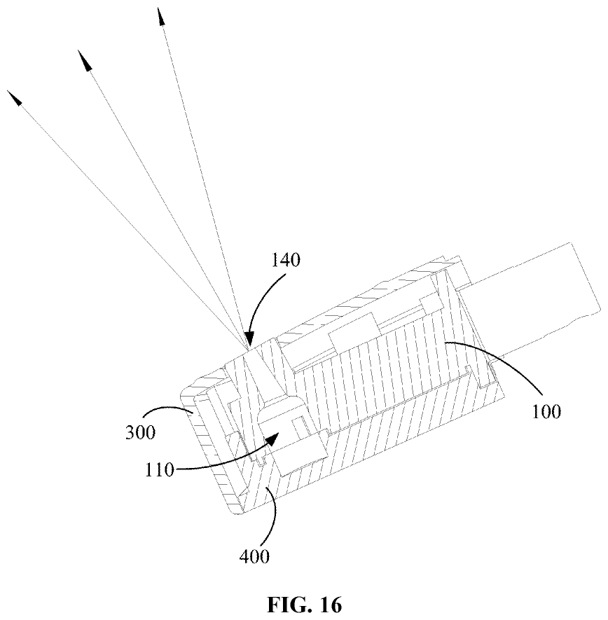

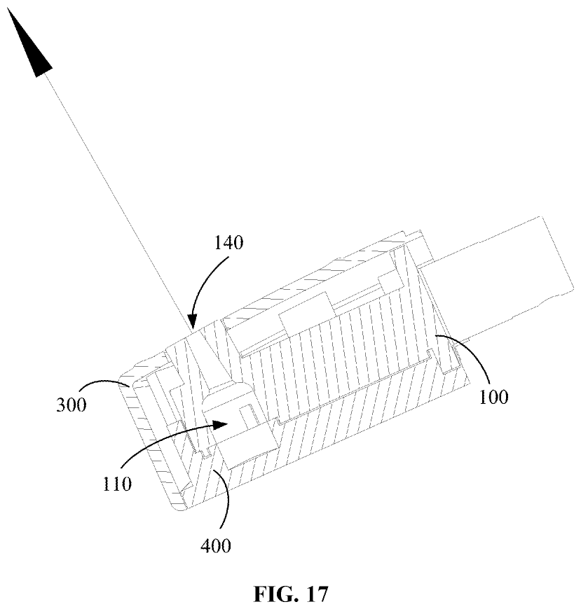

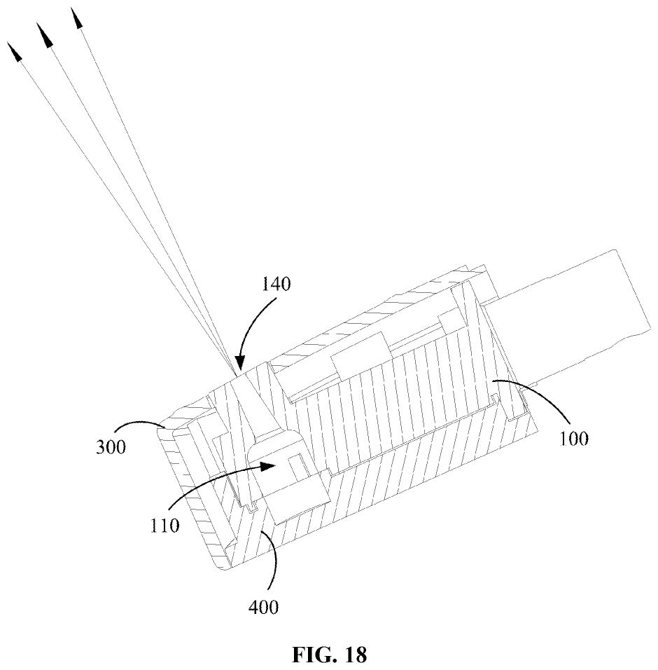

As shown in FIGS. 16 to 18, FIG. 16 is a schematic view illustrating that a water flow in a first state flows out from a water outlet device according to an embodiment of the present disclosure, FIG. 17 is a schematic view illustrating that a water flow in a second state flows out from a water outlet device according to an embodiment of the present disclosure, and FIG. 18 is a schematic view illustrating that a water flow in a third state flows out from a water outlet device according to an embodiment of the present disclosure.

As shown in FIG. 16, the water flow enters the mixing chamber 110 only from the first water inlet 120, and finally, the divergent granular water flow, that is, the water flow in the first state, is sprayed from the water outlet 140.

As shown in FIG. 17, the water flow enters the mixing chamber 110 only from the second water inlet 130, and finally, the columnar water flow, that is, the water flow in the second state, is sprayed from the water outlet 140.

As shown in FIG. 18, the water flow enters the mixing chamber 110 from the first water inlet 120 and the second water inlet 130 at the same time, and finally, the water flow in the third state is sprayed from the water outlet 140.

Another aspect of the present disclosure further provides an intelligent closestool, including the water outlet device of any of the preceding embodiments. Since the intelligent closestool includes the water outlet device of any of the preceding embodiments, the intelligent closestool in this embodiment has all the advantages and beneficial effects of any of the preceding embodiments. The details are not repeated here.

To sum up, the advantages and beneficial effects of the water outlet device and the intelligent closestool according to the embodiments of the present disclosure are described below.

Compared with the method in which different water outlet pipes connect with different water outlet nozzles in the related art, the water outlet device in the embodiment of the present disclosure adopts the technical method in which the first water inlets 120 are disposed in the mixing chamber 110 along the tangential direction and the second water inlets 130 are disposed in the mixing chamber 110 along the radial direction so that the states of the water flows sprayed from the water outlet 140 can be adjusted according to the water intake ratio of the first water inlets 120 and the second water inlets 130, the effect of different water in the same hole is achieved, the advantages of a simple structure and more abundant water flow states are ensured, and the requirements of different users for different water flow states can be satisfied.

In addition, when switching between different water flow states, the water outlet device in the embodiment of the present disclosure can continuously spray warm water without waiting, significantly improving user experience.

In the embodiments of the disclosure, the terms “first”, “second”, and “third” are only used for the purpose of description and cannot be construed as indicating or implying relative importance; the term “a plurality” refers to two or more, unless otherwise expressly limited. The terms such as “mounted”, “connected to each other”, “connected”, and “fixed” are to be understood in a broad sense. For example, “connected” may be “fixedly connected”, “detachably connected”, or “integrally connected, and “connected to each other” may be “connected directly to each other” or “connected indirectly to each other through an intermediary”. For those of ordinary skill in the art, specific meanings of the preceding terms in the embodiments of the disclosure can be understood according to specific conditions.

In the description of the embodiments of the disclosure, it is to be understood that orientations or position relations indicated by terms such as “upper”, “lower”, “left”, “right”, “front”, and “rear” are based on the drawings. These orientations or position relations are intended only to facilitate and simplify the description of the embodiments of the disclosure and not to indicate or imply that a device or unit referred to must have such particular orientations or must be configured or operated in such particular orientations. Thus, these orientations or position relations are not to be construed as limiting the embodiments of the disclosure.

In the description of the specification, the description of terms such as “an embodiment”, “some embodiments”, and “embodiment” means a specific characteristic, structure, material, or feature described in conjunction with the embodiment or the example is included in at least one embodiment or example of the embodiments of the disclosure. In the specification, the illustrative description of the preceding terms does not necessarily refer to the same embodiment or example. Moreover, the described specific characteristic, structure, material, or feature may be combined in an appropriate manner in any one or more embodiments or examples.

The above are only preferred embodiments of the embodiments of the disclosure and are not intended to limit the embodiments of the disclosure. For those skilled in the art, the embodiments of the disclosure may have various modifications and variations. Any modifications, equivalent substitutions, improvements, and the like made within the spirit and principle of the embodiments of the disclosure are within the scope of the embodiments of the disclosure.

1. A water outlet device, comprising:
a core, wherein the core comprises a mixing chamber, at least one first water inlets, at least one second water inlets, and a water outlet, wherein the water outlet connects with the mixing chamber;
wherein a tangential direction of the mixing chamber, a radial direction of the mixing chamber, and an axial direction of the mixing chamber are defined; the at least one first water inlets are disposed in the mixing chamber along the tangential direction so that a water flow entering the mixing chamber from the at least one first water inlets is capable of forming a vortex; and the at least one second water inlets are disposed in the mixing chamber along the axial direction or the radial direction so that a water flow entering the mixing chamber from the at least one second water inlets is capable of forming a stable water flow; and
the water outlet is capable of spraying water flows in different states by adjusting a water intake ratio of the at least one first water inlets and the at least one second water inlets.

2. The water outlet device of claim 1, wherein a centerline of the water outlet coincides with an axis of the mixing chamber.

3. The water outlet device of claim 2, wherein a cross-sectional area of the mixing chamber closer to the water outlet gradually decreases.

4. The water outlet device of claim 1, wherein an aperture of the water outlet is between 1 mm and 2 mm; or
a flow area of the water outlet is between 0.8 mm² and 3 mm².

5. The water outlet device of claim 1, wherein the at least one second water inlets are disposed in the mixing chamber along the radial direction; and
a centerline of one of the at least one first water inlets is basically perpendicular to a centerline of one of the at least one second water inlets.

6. The water outlet device of claim 1, wherein an inner wall surface of the mixing chamber is an arc-shaped curved surface, and a shape of the arc-shaped curved surface is a truncated cone, a cone, an ellipsoid, or a cylinder.

7. The water outlet device of claim 1, further comprising a water diversion valve, wherein the water diversion valve is configured to enable the water flow to selectively enter at least one of: the at least one first water inlets, or the at least one second water inlets.

8. The water outlet device of claim 7, wherein the water diversion valve comprises:
a valve seat comprising a first water diversion hole and a second water diversion hole, wherein the first water diversion hole connects with the at least one first water inlets, and the second water diversion hole connects with the at least one second water inlets; and
a moving member movably connected to the valve seat and comprising a third water diversion hole, wherein the third water diversion hole is capable of connecting with a water supply pipe;
wherein when the moving member moves relative to the valve seat, the third water diversion hole selectively corresponds to at least one of: the first water diversion hole, or the second water diversion hole.

9. The water outlet device of claim 8, wherein the valve seat and the moving member are both disc-shaped and rotatably stacked on each other;
the first water diversion hole, the second water diversion hole, and the third water diversion hole are all waist-shaped holes, and the first water diversion hole and the second water diversion hole extend along a circumferential direction of the valve seat and are arranged at intervals; and
the third water diversion hole extends along a circumferential direction of the moving member.

10. An intelligent closestool, comprising the water outlet device of claim 1.

11. The water outlet device of claim 2, further comprising a water diversion valve, wherein the water diversion valve is configured to enable the water flow to selectively enter at least one of: the at least one first water inlets, or the at least one second water inlets.

12. The water outlet device of claim 3, further comprising a water diversion valve, wherein the water diversion valve is configured to enable the water flow to selectively enter at least one of: the at least one first water inlets, or the at least one second water inlets.

13. The water outlet device of claim 4, further comprising a water diversion valve, wherein the water diversion valve is configured to enable the water flow to selectively enter at least one of: the at least one first water inlets, or the at least one second water inlets.

14. The water outlet device of claim 5, further comprising a water diversion valve, wherein the water diversion valve is configured to enable the water flow to selectively enter at least one of: the at least one first water inlets, or the at least one second water inlets.

15. The water outlet device of claim 11, wherein the water diversion valve comprises:
a valve seat comprising a first water diversion hole and a second water diversion hole, wherein the first water diversion hole connects with the at least one first water inlets, and the second water diversion hole connects with the at least one second water inlets; and
a moving member movably connected to the valve seat and comprising a third water diversion hole, wherein the third water diversion hole is capable of connecting with a water supply pipe;
wherein when the moving member moves relative to the valve seat, the third water diversion hole selectively corresponds to at least one of: the first water diversion hole, or the second water diversion hole.

16. The water outlet device of claim 12, wherein the water diversion valve comprises:
a valve seat comprising a first water diversion hole and a second water diversion hole, wherein the first water diversion hole connects with the at least one first water inlets, and the second water diversion hole connects with the at least one second water inlets; and
a moving member movably connected to the valve seat and comprising a third water diversion hole, wherein the third water diversion hole is capable of connecting with a water supply pipe;
wherein when the moving member moves relative to the valve seat, the third water diversion hole selectively corresponds to at least one of: the first water diversion hole, or the second water diversion hole.

17. The water outlet device of claim 13, wherein the water diversion valve comprises:
a valve seat comprising a first water diversion hole and a second water diversion hole, wherein the first water diversion hole connects with the at least one first water inlets, and the second water diversion hole connects with the at least one second water inlets; and
a moving member movably connected to the valve seat and comprising a third water diversion hole, wherein the third water diversion hole is capable of connecting with a water supply pipe;
wherein when the moving member moves relative to the valve seat, the third water diversion hole selectively corresponds to at least one of: the first water diversion hole, or the second water diversion hole.

18. The water outlet device of claim 15, wherein the valve seat and the moving member are both disc-shaped and rotatably stacked on each other;
the first water diversion hole, the second water diversion hole, and the third water diversion hole are all waist-shaped holes, and the first water diversion hole and the second water diversion hole extend along a circumferential direction of the valve seat and are arranged at intervals; and
the third water diversion hole extends along a circumferential direction of the moving member.

19. The water outlet device of claim 16, wherein the valve seat and the moving member are both disc-shaped and rotatably stacked on each other;
the first water diversion hole, the second water diversion hole, and the third water diversion hole are all waist-shaped holes, and the first water diversion hole and the second water diversion hole extend along a circumferential direction of the valve seat and are arranged at intervals; and
the third water diversion hole extends along a circumferential direction of the moving member.

20. The water outlet device of claim 17, wherein the valve seat and the moving member are both disc-shaped and rotatably stacked on each other;
the first water diversion hole, the second water diversion hole, and the third water diversion hole are all waist-shaped holes, and the first water diversion hole and the second water diversion hole extend along a circumferential direction of the valve seat and are arranged at intervals; and
the third water diversion hole extends along a circumferential direction of the moving member.
